(19) United States
(12) Patent Application Publication
(10) Pub. No.: US 2010/0058368 A1
(43) Pub. Date: Mar. 4, 2010

(54) OPTICAL DISC DRIVE

(76) Inventors: Sojiro Kirihara, Kawasaki (JP); Hiroshi Yamagishi, Chiba (JP)

Correspondence Address: MCDERMOTT WILL & EMERY LLP, 600 13TH STREET, N.W., WASHINGTON, DC, 20005-3096, US

(21) Appl. No.: 12/430,564

(22) Filed: Apr. 27, 2009

(30) Foreign Application Priority Data
Aug. 26, 2008 (JP) 2008-217005

(51) Int. Cl. G11B 17/04

(52) U.S. Cl. 720/601; G9B/17.013

(57) ABSTRACT

A protrusion is formed by bending a part of a skirt at the periphery of a TRV mechanism, or a protrusion is formed at the periphery of a traverse cover, and the protrusion faces a disc tray forming a slight gap in between. When impact is imposed, the protrusion is brought into contact with the disc tray and thereby the TRV mechanism is prevented from largely deforming without adding another part in order to enhance the resistance.

### CLAIM OF PRIORITY

The present application claims priority from Japanese patent application serial no. JP 2008-217005, filed on Aug. 26, 2008, the content of which is hereby incorporated by reference into this application.

### BACKGROUND OF THE INVENTION

1. Field of the Invention

The present invention relates to an optical disc drive in particular to an optical disc drive that can reduce the deformation of a mechanical part caused by external vibration and impact.

2. Description of the Related Art

In the case of an optical disc drive mounted on a mobile PC (Personal Computer), a DVD (Digital Versatile Disc) camera/recorder, a BD (Blu-ray Disc) camera/recorder, or the like, the reduction of the thickness and the weight is advancing in recent years. This is a requirement necessary for securing convenient portability but at the same time insufficient strength thereof is a problem when external vibration or impact is imposed. When a mechanical part deforms in particular, drive performance including track tracing capability on an optical disc is greatly affected.

In order to solve the problem, a means for reducing the thickness of a device without deteriorating resistance to vibration and impact by installing an attachment having an insulator onto a record reproduction unit is disclosed in Japanese Patent Application Laid-Open Publication No. 2006-134543.

Further, a means for attenuating vibration by installing an elastic stopper onto a mechanical unit including an optical pickup so that the stopper may hit a case when vibration occurs in excess of a prescribed stroke is disclosed in Japanese Utility Model Application Laid-Open Publication No. H5-36695.

### SUMMARY OF THE INVENTION

As shown in Japanese Patent Application Laid-Open Publication No. 2006-134543 and Japanese Utility Model Application Laid-Open Publication No. H5-36695, resistance to vibration and impact has been secured by adding a part such as an attachment having an insulator or an elastic stopper in the past. In order to further promote the reduction of thickness and weight hereafter, a method for securing performance without the addition of another part is required.

An object of the present invention is to solve the problem and provide an optical disc drive that can secure resistance to vibration and impact in particular an optical disc drive that can secure resistance to vibration and impact without the addition of another part.

An optical disc drive according to the present invention to attain the above object: is the optical disc drive having a disc motor to rotate an optical disc, a disc tray that is installed on the optical disc mounting side of the disc motor and transfers the optical disc from the exterior to the interior or from the interior to the exterior of the drive when the optical disc is attached to or detached from the device, and a traverse that is placed between the disc tray and the disc motor and supports the disc motor, wherein a flange is formed at the periphery of the traverse to face the bottom face of the disc tray.

Further, another optical disc drive according to the present invention is the optical disc drive having a disc motor to rotate an optical disc, a disc tray that is installed on the optical disc mounting side of the disc motor and transfers the optical disc from the exterior to the interior or from the interior to the exterior of the drive when the optical disc is attached to or detached from the device, a traverse that is placed between the disc tray and the disc motor and supports the disc motor, and a traverse cover that is attached to the traverse and is used for covering the disc tray side of the traverse, wherein a flange is formed at the periphery of the traverse cover to face the bottom face of the disc tray.

According to the present invention, an optical disc drive capable of securing resistance to vibration and impact is provided, and an optical disc drive causing less track trace failure during operation and having good usability is provided.

### BRIEF DESCRIPTION OF THE DRAWINGS

These and other features, objects and advantages of the present invention will become more apparent from the following description when taken in conjunction with the accompanying drawings wherein:

FIG. 1A is a plan view of a TRV mechanism in an optical disc drive according to an embodiment of the present invention, and FIG. 1B is a plan view of a traverse thereof;

FIG. 2 is a plan view of a conventional traverse;

FIG. 3 is a side view of a TRV mechanism;

FIG. 4A is a plan view of an optical disc drive according to an embodiment of the present invention;

FIG. 4B is an enlarged view of a part of the optical disc drive shown in FIG. 4A;

FIG. 4C is a sectional view of a part of the optical disc drive shown in FIG. 4B;

FIGS. 5A and 5B show a traverse cover according to another embodiment of the present invention; FIG. 5A is a plan view and FIG. 5B is a side view;

FIG. 6 is a plan view of a conventional traverse cover; and

FIG. 7 is a sectional view showing a part of an optical disc drive according to another embodiment of the present invention.

### DETAILED DESCRIPTION OF THE EMBODIMENTS

Embodiments of the present invention are hereunder explained in reference to the drawings.

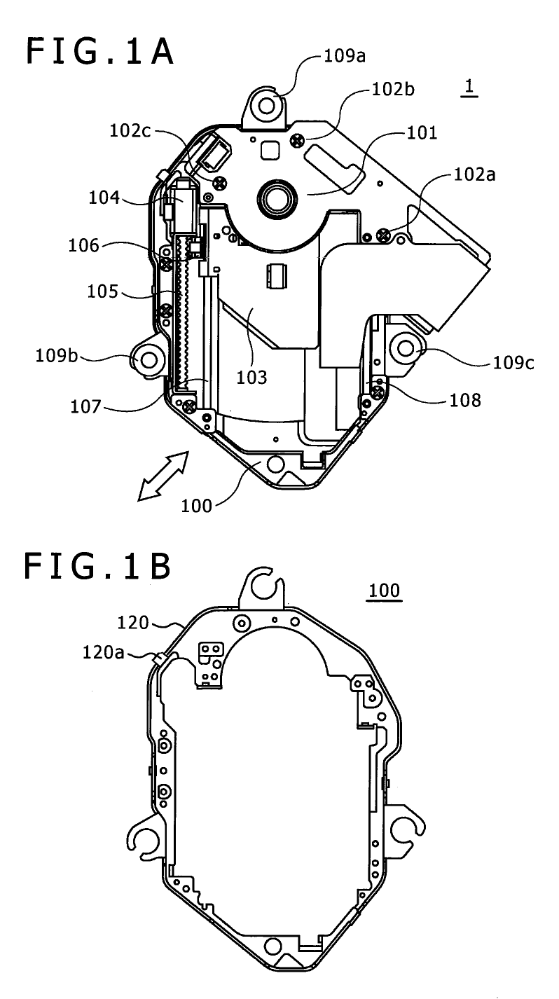

FIGS. 1A and 1B show plan views, taken from the bottom side of the device, of a traverse mechanism assembly 1 (hereunder abbreviated as a TRV mechanism) in an optical disc drive according to the present invention. The TRV mechanism is equipped with the most important constituent elements of the mechanical system relating to the record reproduction operation of the optical disc drive and includes a disc motor to rotate an optical disc, an optical pickup unit to record and reproduce signals, and a transfer mechanism. FIG. 1A shows a general view of the TRV mechanism 1 and FIG. 1B shows a traverse 100 constituting the base part thereof. The arrow at the lower left in FIG. 1A shows the direction of the transfer of an optical disc not shown in the figure when the optical disc is loaded on or ejected from the optical disc drive. A disc tray to receive and transfer an optical disc from the exterior to the interior or from the interior to the exterior of the device when the optical disc is loaded or ejected is placed behind the TRV mechanism 1 although it is not shown in the figure. The optical disc mounted on the disc tray and transferred from the exterior to the interior of the device when it is loaded: is attached to a damper installed on the rear side of the figure (on the upper face side of the device) on an extension of the axis of rotation of the disc motor 101; and is rotated with the disc motor 101.

The disc motor 101 is attached to the traverse 100 with retainers 102a, 102b, and 102c such as, for example, ordinary screws. That is, the disc motor 101 is supported at three points in a cantilevered manner and, when vibration or impact is imposed from the exterior of the device, it sometimes happens that slump moment occurs and the TRV mechanism 1 itself deforms and transfers in some cases.

The optical pickup unit (hereunder abbreviated as OPU) 103 records and reproduces signals at an indicated position on the optical disc by transferring on a guide main shaft 107 and a guide layer shaft 108 in accordance with the rotation of a slide motor 104, a screw 105 directly connected to the axis of rotation thereof, and a gear 106.

Although the slump moment can be avoided if the disc motor 101 can be supported at four points, the lower side of the disc motor 101 in the figure is used as a space for the transfer of the OPU 103 as shown in FIG. 1 and hence it is difficult to secure the fourth support point.

Here, the traverse 100 is attached to a bottom case not shown in the figure through dampers 109a, 109b, and 109c at three points, the dampers being made of rubber or the like.

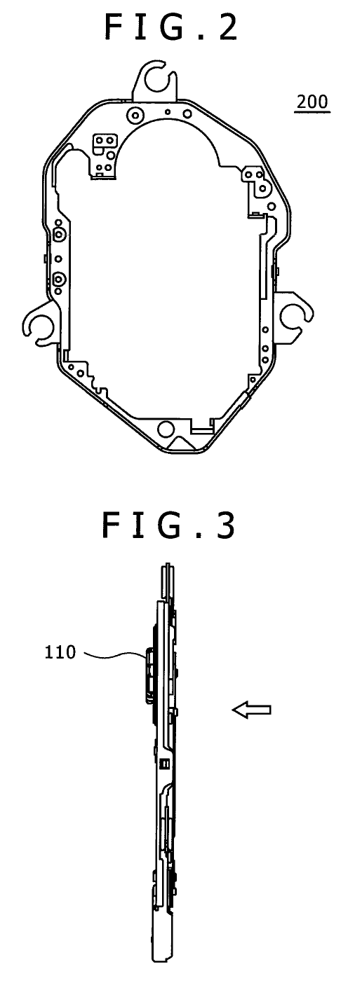

A feature of the present embodiment is, as shown in FIG. 1B, that a protrusion 120a is formed by bending a part of a skirt 120 formed at the periphery of the traverse 100 for example. In contrast, a conventional traverse 200 has no flange as shown in FIG. 2. In the present embodiment, the protrusion 120a faces the bottom face of a disc tray not shown in the figure usually at a slight gap. The TRV mechanism 1 is prevented from largely deformed and transferred by being brought into contact the protrusion 120a with the disc tray when vibration or impact is imposed.

Successively, the state where impact is actually imposed is explained with FIG. 3. FIG. 3 is a side view of the TRV mechanism 1 viewed from the left side of FIG. 1A. The reference numeral 110 represents a damper to fix an optical disc.

The case where impact is imposed from the bottom face side of the disc motor 101 as shown with the arrow in the figure is discussed. As stated above, the disc motor 101 is supported on the traverse 100 at three points in a cantilevered manner. As a result, slump moment is caused by impact force, the TRV mechanism is drawn to the upper face side (to the left side in FIG. 3) at the same time, and constituent elements including the OPU 103 move. This causes failure in record and reproduction operation and track trace and is troublesome.

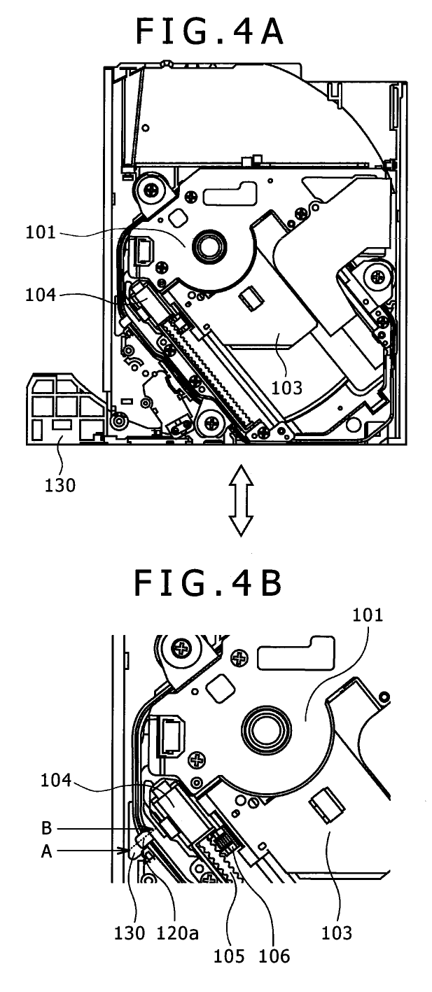

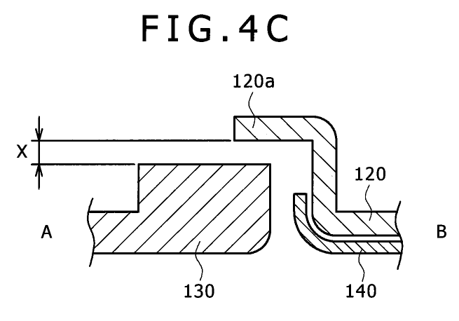

Successively, the position and the role of the protrusion 120a are explained in reference to FIGS. 4A to 4C. FIG. 4A is a plan view of an optical disc drive according to the present invention viewed from the bottom face side. In addition to the TRV mechanism 1 shown in FIG. 1, a disc tray 130 is added on the backside thereof. The arrow at the lower part in FIG. 4A indicates the direction in which an optical disc is transferred when it is loaded or ejected. FIG. 4B is a partially enlarged view centered on a disc motor 101 and a protrusion 120a. FIG. 4C is an enlarged sectional view taken on the broken line A-B in FIG. 4B. Here, the reference numeral 140 represents a traverse cover that will be described later.

The protrusion 120a faces a part of the bottom face of the disc tray 130 located on the backside in FIGS. 4A and 4B. As shown in the sectional view of FIG. 4C, a gap indicated as X in the figure is formed between the protrusion 120a and the bottom face of the disc tray 130. In the present embodiment, the gap is set so as to be smaller than the distance of the withdrawal of the aforementioned dampers 109a, 109b, and 109c when impact is imposed as shown in FIG. 3. In a usual case, the gap exists between the protrusion 120a and the disc tray 130 and hence there is no chance of interfering with each other and hindering the operations such as loading and ejecting of an optical disc. On the contrary, in the case where impact is imposed as shown in FIG. 3, if the impact is light, the impact is absorbed by the withdrawal of the dampers 109a, 109b, and 109c and does not affect the TRV mechanism. When the impact is heavy, the protrusion 120a and the disc tray 130 immediately are brought into contact with each other and hence the TRV mechanism 1 is prevented from transferring largely and deforming. Further for example, it is possible to prevent constituent elements including a slide motor 104 from largely protruding on the upper face side of the device through the hole of the traverse 100.

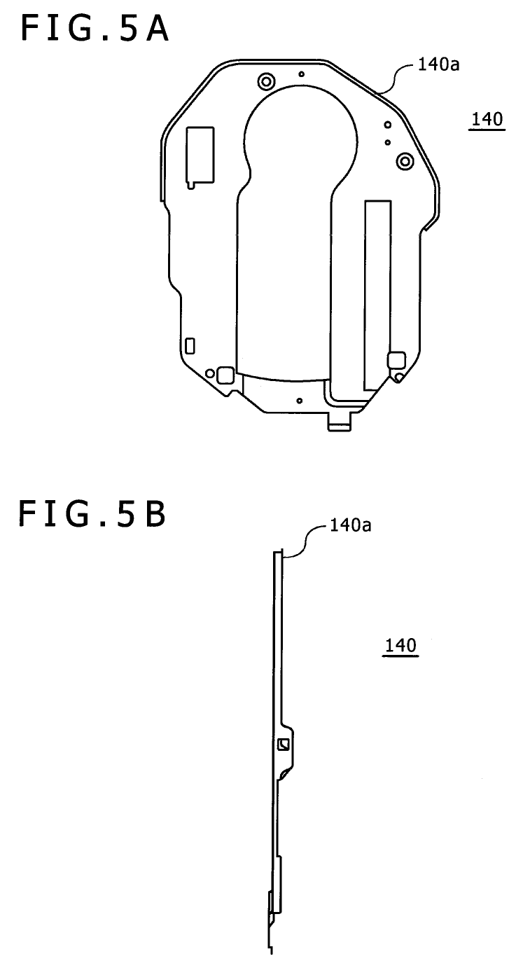

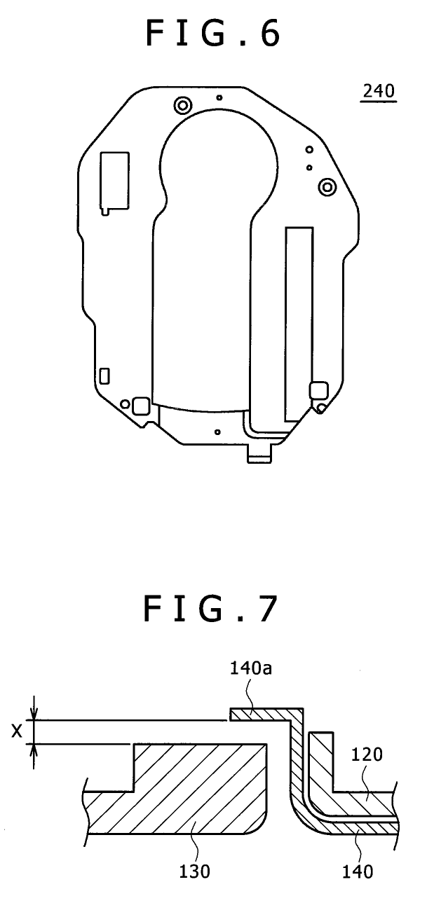

Successively, another embodiment according to the present invention is explained in reference to FIGS. 5A and 5B and 7. FIG. 5A is a plan view of a traverse cover 140 attached to a traverse 100 according to the present invention on the side facing a disc tray 130. This is also viewed from the side of the bottom face of an optical disc drive. FIG. 5B is a side view viewed from the left side of the FIG. 5A. In the present embodiment, a protrusion 140a is formed by bending a part of the periphery of the traverse cover 140. As a result, in the same way as the protrusion 120a, when impact is imposed, the protrusion 140a is brought into contact with the disc tray 130. As a result, a TRV mechanism 1 is prevented from transferring largely and deforming. In contrast, a conventional traverse cover 240 has no such a function because it does not have a flange as shown in FIG. 6.

FIG. 7 shows a partially sectional view of the embodiment. The figure corresponds to FIG. 4c. Here, unlike the case of FIG. 4c, a protrusion 140a is formed not at the skirt 120 but at a traverse cover 140 of a traverse 100. The functions thereof are the same as the case of FIG. 4C and thus explanations are omitted.

A counterpart facing the protrusion 120a or 140a and being brought into contact with it when vibration or impact is imposed is not necessarily limited to the disc tray 130. In an optical disc drive having a disc tray 130 however, the easiest way is in most cases that the protrusion 120a or 140a is formed so as to face the disc tray 130 that is the counterpart facing the TRV mechanism 1 at a large area.

The present invention is not limited to the aforementioned embodiments. Any means may be included in the present invention as long as it can prevent a TRV mechanism 1 from largely transferring and deforming by impact.

For example, although the protrusion 120a formed at the skirt 120 of the traverse 100 is narrower in width than the protrusion 140a formed at the traverse cover 140 in the figures, this is not a limiting condition. The protrusion 120a may be formed widely in the direction of the periphery of the traverse 100 or the protrusion 140a may be formed more narrowly in the direction of the periphery of the traverse cover 140 than the protrusion shown in the figure. Further, the number of the flange is not limited to one and plural flanges may be formed at the periphery of the traverse 100 or the traverse cover 140. Various modified examples can be accepted as long as the protrusion 120a or 140a does not interfere with other constituent elements in ordinary operations.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disc drive comprising:
a disc motor to rotate an optical disc;
a disc tray that is installed on the optical disc mounting side of the disc motor and transfers the optical disc from the exterior to the interior or from the interior to the exterior of the drive when the optical disc is attached to or detached from the device; and
a traverse that is placed between the disc tray and the disc motor and supports the disc motor,
wherein a flange is formed at the periphery of the traverse to face the bottom face of the disc tray.

2. An optical disc drive comprising:
a disc motor to rotate an optical disc;
a disc tray that is installed on the optical disc mounting side of the disc motor and transfers the optical disc from the exterior to the interior or from the interior to the exterior of the drive when the optical disc is attached to or detached from the device;
a traverse that is placed between the disc tray and the disc motor and supports the disc motor; and
a traverse cover that is attached to the traverse and is used for covering the disc tray side of the traverse,
wherein a flange is formed at the periphery of the traverse cover to face the bottom face of the disc tray.

3. The optical disc drive according to claim 1, further comprising:
a bottom case with which the bottom face side of the optical disc drive is covered; and
an elastic damper inserted between the bottom case and the traverse,
wherein the gap between the flange and the bottom face of the disc tray is set so as to be shorter than the length of the shrinkage of the dampers when the dampers compress.

4. The optical disc drive according to claim 2, further comprising:
a bottom case with which the bottom face side of the optical disc drive is covered; and
an elastic damper inserted between the bottom case and the traverse,
wherein the gap between the flange and the bottom face of the disc tray is set so as to be shorter than the length of the shrinkage of the dampers when the dampers compress.
